(19) United States
(12) Patent Application Publication
(10) Pub. No.: US 2026/0298202 A1
(43) Pub. Date: Oct. 1, 2026

(54) WIND-SOLAR-WAVE SYNERGISTIC DISPATCHABLE POWER GENERATION DEVICES

(71) Applicant: GUANGDONG UNIVERSITY OF TECHNOLOGY, Guangzhou (CN)

(72) Inventors: Han SUN, Guangzhou (CN); Lingzhi XU, Guangzhou (CN); Dapeng ZOU, Guangzhou (CN); Xiaotong LIN, Guangzhou (CN); Zedong MI, Guangzhou (CN); Yong REN, Guangzhou (CN); Yuxin HUANG, Guangzhou (CN); Jingyi LIU, Guangzhou (CN); Jingcheng HOU, Guangzhou (CN)

(73) Assignee: GUANGDONG UNIVERSITY OF TECHNOLOGY, Guangzhou (CN)

(21) Appl. No.: 19/678,108

(22) Filed: May 14, 2026

Related U.S. Application Data
(63) Continuation of application No. PCT/CN2026/085163, filed on Mar. 23, 2026.

(30) Foreign Application Priority Data
Mar. 25, 2025 (CN) 202510359637.8

(51) Int. Cl. F03D 9/00; B63B 35/44; B63B 39/03; B63B 79/15; B63B 79/40; F03B 13/14; F03D 9/11; H02S 10/12; H02S 10/20; H02S 10/40

(52) U.S. Cl. CPC F03D 9/007; B63B 35/44; B63B 39/03; B63B 79/15; B63B 79/40; F03B 13/14; F03D 9/11; H02S 10/12; H02S 10/20; H02S 10/40; B63B 2035/4453; B63B 2035/446; B63B 2035/4466; F05B 2220/708

(57) ABSTRACT

Disclosed is a wind-solar-wave synergistic dispatchable power generation device and method. The method includes: determining a current sea state based on environmental data collected in real time by a sensor module; performing intelligent switching or synergistic operation of a photovoltaic power generation module, a wind power generation module, and a wave power generation module based on the current sea state, and storing solar energy, wind energy, and wave energy in an energy storage module; when the obtained current sea state meets an extreme sea state condition, controlling a buoyancy adjustment module to activate a protection mode, closing the photovoltaic power generation module and the wind power generation module, adjusting the housing to submerge to a safe depth, and simultaneously switching to the wave power generation module for independent power generation by the wave power generation module; and when the collected environmental data meets a release condition, releasing the protection mode, adjusting the housing to ascend to a sea surface, and the intelligent dispatching module restoring a normal dispatching and power generation function.

### CROSS-REFERENCE TO RELATED APPLICATIONS

This application is a Continuation of International Application No. PCT/CN2026/085163, filed on Mar. 23, 2026, which claims priority to the Chinese Patent Application No. 202510359637.8, filed on Mar. 25, 2025, the contents of each of which are hereby incorporated by reference.

### TECHNICAL FIELD

The present disclosure generally relates to the technical field of offshore devices, and in particular to a wind-solar-wave synergistic dispatchable power generation device and method.

### BACKGROUND

With the continuous development of the global economy and the increasing population, energy demand exhibits an unprecedented growth trend. Wind energy, solar energy, and wave energy, as three highly promising renewable energy sources, demonstrate broad application prospects in the energy field due to their characteristics of large reserves, wide distribution, and cleanliness without pollution.

However, despite the many advantages of these renewable energy sources, their development and utilization also face numerous challenges. A single renewable energy power generation method is often strictly limited by natural environmental conditions. For example, although wind power generation is technologically mature and widely used, the efficiency of wind power generation is highly susceptible to meteorological factors such as wind speed and wind direction. These limiting factors not only affect the stability and reliability of single-energy power generation systems but also make these systems difficult to meet large-scale, continuous, and stable energy demands.

Therefore, how to overcome these limiting factors and achieve efficient, stable, and sustainable utilization of renewable energy has become an important issue urgently needing to be solved in the current energy field.

### SUMMARY

One or more embodiments of the present disclosure provide a wind-solar-wave synergistic dispatchable power generation device. The device includes a housing, a sensor module, a buoyancy adjustment module, a photovoltaic power generation module, a wind power generation module, a wave power generation module, an energy storage module, and an intelligent dispatching module. The sensor module, the buoyancy adjustment module, the photovoltaic power generation module, the wind power generation module, the wave power generation module, the energy storage module, and the intelligent dispatching module are installed inside the housing. The sensor module includes a plurality of sensors, and the plurality of sensors are configured to collect environmental data in real time. A water storage compartment is provided inside the housing, and an anchor chain is connected to an exterior of the housing. The buoyancy adjustment module is configured to automatically intake water into or drain water from the water storage compartment according to an activation state of a protection mode and adjust a tension of the anchor chain, thereby adjusting a buoyancy status of the housing. The photovoltaic power generation module includes a plurality of solar panels, the plurality of solar panels are configured to control an opening-closing state, an azimuth angle, and an elevation angle through a drive motor, and the plurality of solar panels are configured to perform photovoltaic power generation to obtain solar energy. The wind power generation module includes a helical generator, and the helical generator is configured to perform wind power generation to obtain wind energy. The wave power generation module includes a steel disc and two annular permanent magnets connected by a spring telescopic rod and a central rigid shaft, the steel disc moves between the two annular permanent magnets, and the steel disc is configured to float up and down with wave oscillations, convert kinetic energy of waves into mechanical energy, and generate electric current through electromagnetic induction to obtain wave energy. The energy storage module is configured to store the solar energy, the wind energy, and the wave energy. The intelligent dispatching module is configured to control the buoyancy adjustment module to activate or release the protection mode according to the environmental data collected in real time, and to switch or synergistically operate the photovoltaic power generation module, the wind power generation module, and the wave power generation module according to the protection mode of the buoyancy adjustment module.

### BRIEF DESCRIPTION OF THE DRAWINGS

FIG. 1 is a schematic diagram illustrating a structure of a wind-solar-wave synergistic dispatchable power generation device according to some embodiments of the present disclosure.

FIG. 2 is a flowchart illustrating an exemplary process of a wind-solar-wave synergistic dispatchable power generation method according to some embodiments of the present disclosure.

FIG. 3 is a schematic diagram illustrating an exemplary process for determining a target control strategy according to some embodiments of the present disclosure.

Reference numerals in the drawings: 1, housing; 2, sensor module; 3, buoyancy adjustment module; 4, photovoltaic power generation module; 5, wind power generation module; 6, wave power generation module; 7, intelligent dispatching module; 8, energy storage module.

### DETAILED DESCRIPTION

The technical solution of the present disclosure is further described below in conjunction with the accompanying drawings and by way of specific embodiments.

In the description of the present disclosure, it should be understood that the terms “center”, “longitudinal”, “transverse”, “length”, “width”, “thickness”, “upper”, “lower”, “left”, “right”, “vertical”, “horizontal”, “top”, “bottom”, “inner”, “outer”, “axial”, “radial”, “circumferential”, or the like, refer to orientation or positional relationships based on the orientation or positional relationships shown in the accompanying drawings, and are merely for convenience in describing and simplifying the present disclosure, rather than indicating or implying that the device or element referred to must have a specific orientation or be constructed and operated in a specific orientation. Therefore, these terms should not be construed as limiting the present disclosure.

In addition, the terms “first” and “second” are merely used for descriptive purposes and should not be construed as indicating or implying relative importance or implicitly indicating the number of technical features indicated. Thus, features defined by “first” and “second” may explicitly or implicitly include one or more such features. In the description of the present disclosure, unless otherwise specified, the meaning of “more” or “a plurality of” is two or more.

In the description of the present disclosure, it should be noted that unless otherwise expressly specified and defined, the terms “installed”, “connected”, and “coupled” should be broadly understood. For example, they may be fixed connections, removable connections, or integrally connected; they may be directly connected or indirectly connected through an intermediate medium and may be internal communication between two elements. For those of ordinary skill in the art, the specific meanings of the above terms in the present disclosure may be understood according to specific circumstances.

One or more embodiments of the present disclosure provide a wind-solar-wave synergistic dispatchable power generation device. The device combines three renewable energy power generation methods, namely wind power generation, solar power generation, and wave power generation, to solve a problem of singleness of existing power generation devices in the prior art.

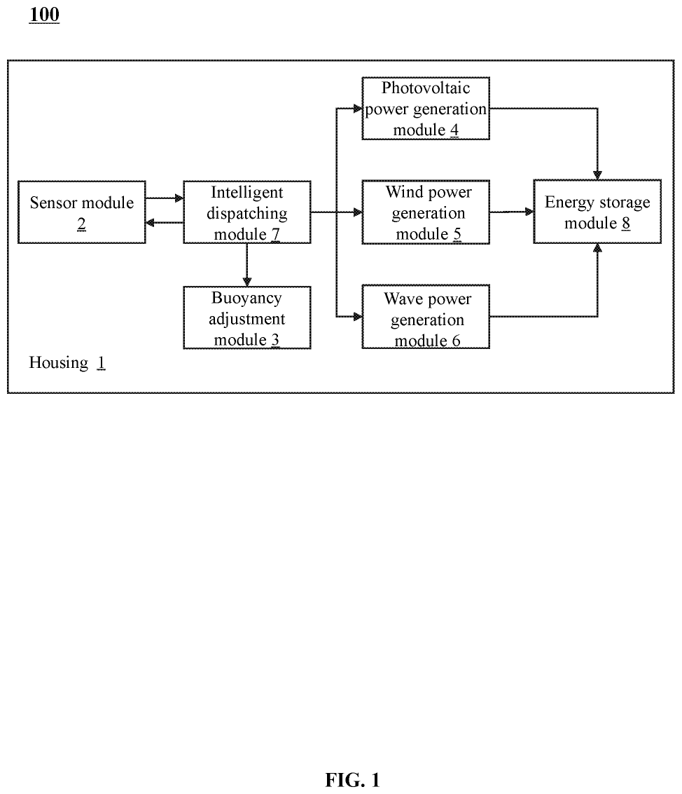

FIG. 1 is a schematic diagram illustrating a structure of a wind-solar-wave synergistic dispatchable power generation device according to some embodiments of the present disclosure. In some embodiments, as shown in FIG. 1, a wind-solar-wave synergistic dispatchable power generation device (hereinafter referred to as device 100) may include a housing 1 and a sensor module 2, a buoyancy adjustment module 3, a photovoltaic power generation module 4, a wind power generation module 5, a wave power generation module 6, and an intelligent dispatching module 7, and an energy storage module 8 installed inside the housing 1.

In some embodiments, the aforementioned intelligent dispatching module 7 and other logic units involved in data processing, determining, and control (e.g., a control logic unit of the buoyancy adjustment module 3) may be physically or logically integrated into at least one processor, or implemented as computer-readable instructions executed by the at least one processor.

In some embodiments, the processor may be implemented using any suitable type of computing or control hardware. Exemplarily, the processor may include, but is not limited to, one or more general-purpose processors (e.g., a central processing unit (CPU)), microprocessors, microcontrollers, programmable logic devices (PLDs), or any combination thereof designed to perform the functions of the present disclosure.

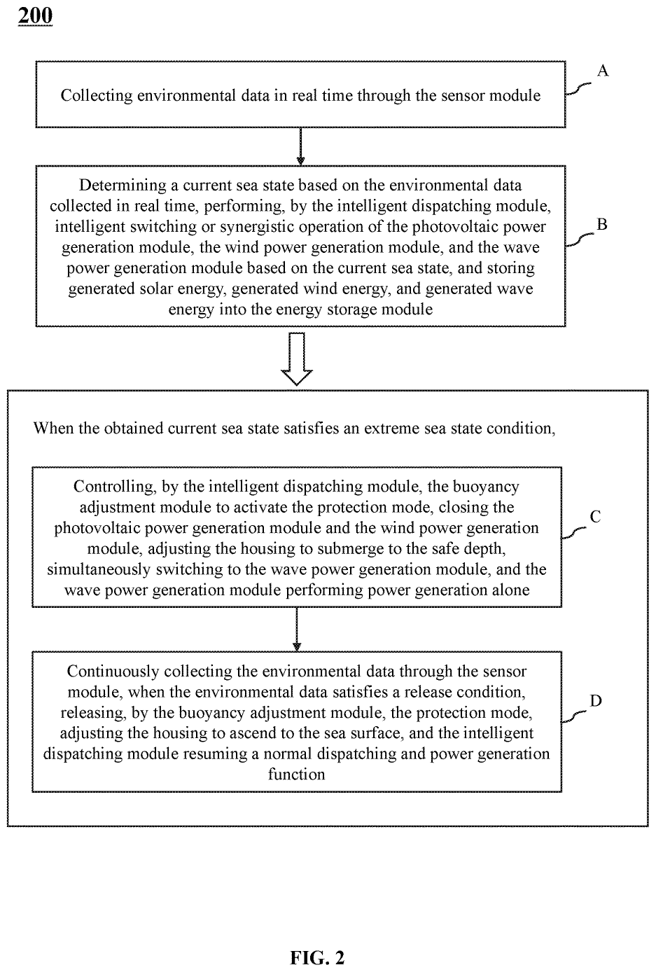

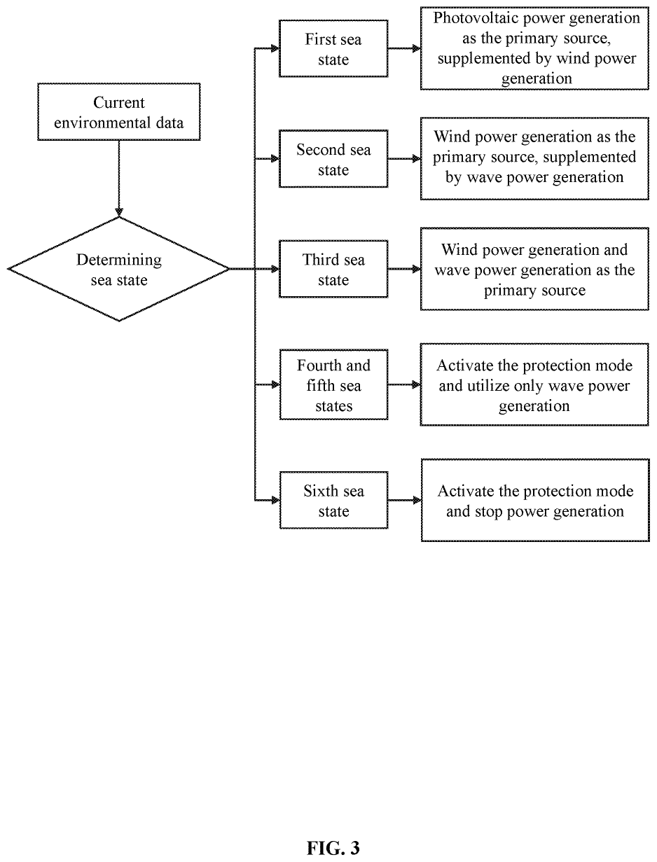

In some embodiments of the present disclosure, the processor is configured to receive and process data from the sensor module 2, determine a target control strategy, and send corresponding control signals to the buoyancy adjustment module 3, the photovoltaic power generation module 4, the wind power generation module 5, and the wave power generation module 6, to implement the wind-solar-wave synergistic dispatchable power generation method described in the present disclosure. More descriptions regarding this section may be found elsewhere in the present disclosure (e.g., FIG. 2, FIG. 3, and related descriptions thereof).

In some embodiments, the sensor module 2 may include a plurality of sensors, and the plurality of sensors are configured to collect environmental data in real time.

In some embodiments, the environmental data may include natural condition data and housing data. In some embodiments, the natural condition data may include wave information, an illumination intensity, a wind speed, wind direction data, and meteorological data. In some embodiments, the housing data may include an inclination angle, an attitude depth, a vertical displacement, and a submergence depth of the housing 1. In some embodiments, the housing data may further include variation ranges of a motion amplitude, a yaw angle, and an elevation angle of the housing 1 at the submergence position, or the like.

In some embodiments, the sensor module 2 may include a wave height gauge, an illumination sensor, a wind sensor, a meteorological sensor, an attitude sensor, a pose sensor, an acceleration sensor, and a depth sensor, or the like.

In some embodiments, the wave height gauge is configured to monitor wave information including a wave height and a wave frequency.

In some embodiments, the wave height gauge may include, but is not limited to, an ultrasonic wave height gauge, a radar wave height gauge, a pressure-type wave height sensor, or a float-type wave meter.

The wave height refers to a vertical distance between an adjacent wave crest and a wave trough. The wave frequency refers to a number of complete wave oscillations per unit time. In some embodiments, the wave frequency and the wave period have an inverse relationship. More descriptions regarding the wave period may be found elsewhere in the present disclosure (e.g., FIG. 3 and related descriptions thereof).

In some embodiments, the illumination sensor is configured to monitor the illumination intensity on the sea surface.

In some embodiments, the illumination sensor may include, but is not limited to, a silicon photocell sensor, a pyranometer, or a photoresistor. For example, the pyranometer may be installed on a top surface of the housing 1, which is configured to measure a total solar irradiance.

The illumination intensity refers to a solar radiation energy received per unit area, with a unit of Watts per square meter (W/m²).

In some embodiments, the wind sensor is configured to obtain the wind speed and wind direction data.

In some embodiments, the wind sensor may include, but is not limited to, a cup anemometer, an ultrasonic wind speed and direction meter, or a pitot tube.

The wind speed refers to a speed of air movement relative to the Earth's surface. The wind direction refers to a direction from which wind blows, which may be indicated by an angle (0° to 360°) relative to due north.

In some embodiments, the meteorological sensor is configured to collect meteorological data including a temperature, a humidity, and a precipitation. In some embodiments, the meteorological data may also be referred to as meteorological conditions.

In some embodiments, the meteorological sensor may include, but is not limited to, a thermistor thermometer, a capacitive humidity sensor, a tipping bucket rain gauge, or an ultrasonic meteorological monitor.

In some embodiments, the attitude sensor is configured to collect the inclination angle and the attitude depth of the housing 1.

In some embodiments, the attitude sensor may include, but is not limited to, a nine-axis inertial measurement unit (IMU), a micro-electromechanical system (MEMS) gyroscope, or an electronic compass.

The inclination angle refers to a deviation angle of a central axis of the housing 1 relative to a vertical direction or a horizontal datum plane. The attitude depth refers to an instantaneous vertical displacement of a specific reference point of the housing 1 relative to a balance position, which is collected by the attitude sensor when the device 100 undergoes pose changes such as tilting, rolling or pitching.

In some embodiments, the pose sensor is configured to collect a variation range of a motion amplitude, a variation range of a yaw angle, and a variation range of an elevation angle of the housing 1 at a submergence position.

The pose sensor refers to a device that monitors position coordinate accuracy and motion trajectory stability of the device 100 in a three-dimensional space. Exemplarily, the pose sensor may include, but is not limited to, a high-precision Global Positioning System (GPS/BeiDou) receiver for water surface application and an acoustic positioning system for underwater application.

The motion amplitude refers to a maximum value of a periodic displacement of the housing 1 at the submergence position due to water flow. The yaw angle refers to an angle of rotation of the housing 1 about a vertical axis. The elevation angle refers to an angle of swing of the housing 1 in a vertical plane.

In some embodiments, the pose sensor is further configured to monitor a swing amplitude, a swing duration, and a swing frequency of the device 100. More descriptions regarding this section may be found elsewhere in the present disclosure (e.g., FIG. 2 and related descriptions thereof).

In some embodiments, the acceleration sensor is configured to measure acceleration variation data of the housing 1 to obtain the vertical displacement.

In some embodiments, the acceleration sensor may employ a high precision triaxial MEMS accelerometer, a piezoelectric accelerometer, or a capacitive accelerometer.

The acceleration variation data refers to a velocity variation vector of the housing 1 per unit time as measured by the sensor. The vertical displacement refers to a vertical movement distance of the housing 1 relative to an initial equilibrium position or the sea surface under the action of wave forces. In some embodiments, the processor may determine the vertical displacement of the housing 1 in real time by performing mathematical algorithm processing such as secondary integration on the collected vertical acceleration variation data.

In some embodiments, the depth sensor is configured to monitor the submergence depth of the housing 1 in real time.

In some embodiments, the depth sensor may employ a hydrostatic sensor, a piezoresistive sensor, or an ultrasonic depth sensor. Exemplarily, the depth sensor is installed at a position on a bottom or a side wall of the housing 1 that is in direct contact with seawater.

The submergence depth refers to a vertical distance by which a designated reference point of the housing 1 (e.g., a center of gravity or a datum plane) is located below the sea surface.

In some embodiments, a water storage compartment is provided inside the housing 1, and an anchor chain is connected to an exterior of the housing 1. In some embodiments, the buoyancy adjustment module 3 is configured to automatically intake water into or drain water from the water storage compartment according to an activation state of the protection mode, adjust a tension of the anchor chain, and adjust a buoyancy status of the housing 1.

The water storage compartment refers to a containment chamber provided inside the housing 1. The water storage compartment may be configured to contain seawater or other ballast media. In some embodiments, the water storage compartment is in communication with an external body of water, and the volume of water inside the water storage compartment (i.e., the water storage volume) may be dynamically adjusted through fluid control components, such as valves, water pumps. By increasing or decreasing the volume of water in the water storage compartment, the overall weight and a draft depth of the device 100 can be changed, thereby allowing the device 100 to perform ascending and submerging movements between the sea surface and the safe depth underwater.

The anchor chain refers to a mooring component that connects an exterior of the housing 1 to a seabed (or an underwater fixed base). In some embodiments, the anchor chain can synergistically operate with the buoyancy adjustment module 3 to provide a downward tension that resists buoyancy and environmental disturbances (e.g., ocean currents, waves).

In some embodiments, the buoyancy adjustment module 3 may include a physical execution unit and a control logic unit. The physical execution unit includes an inlet/drain pump assembly (e.g., a bidirectional electric pump) provided at a bottom of the water storage compartment, and a tension adjustment winch connected to the anchor chain. The control logic unit is integrated into the processor.

Exemplarily, when the protection mode is activated, the buoyancy adjustment module 3 may control the inlet/drain pump assembly to automatically intake water into the water storage compartment based on a preset water intake volume, causing the total weight of the housing 1 to be greater than buoyancy to trigger a submerging movement, and control the electric winch to adjust the tension of the anchor chain based on a preset submergence tension, thereby guiding the housing 1 to stably submerge to the safe depth. When the protection mode is released, the buoyancy adjustment module 3 may control the inlet/drain pump assembly to discharge the seawater from the water storage compartment based on a preset water discharge volume, causing the total weight of the housing 1 to be less than buoyancy to drive the device to ascend automatically, and simultaneously control the electric winch to retract the anchor chain and adjust the tension based on a preset ascending tension until the housing 1 reaches the sea surface position and returns to a normal buoyancy status. The preset water intake volume, the preset water discharge volume, the preset submergence tension, and the preset ascending pressure may be set based on historical experience or actual demand.

More descriptions regarding adjusting the buoyancy status of the housing 1 may be found elsewhere in the present disclosure (e.g., FIG. 3 and related descriptions thereof).

In some embodiments, the photovoltaic power generation module 4 may include a plurality of solar panels, and the plurality of solar panels are configured to control an opening-closing state, an azimuth angle, and an elevation angle through a drive motor. In some embodiments, the plurality of solar panels are configured to perform photovoltaic power generation to obtain solar energy.

Exemplarily, the photovoltaic power generation module 4 may control the drive motor to drive the plurality of solar panels to switch from a closed state to an open state for photovoltaic power generation, and the processor may control the drive motor to drive a horizontal axis and a vertical axis of the solar panels to rotate based on the preset azimuth angle and the preset elevation angle, so as to adjust the azimuth and the elevation angle of the solar panels such that they are always aligned with an incident direction of sunlight. The preset azimuth angle and the preset elevation angle may be determined by querying the preset table based on a current time. The preset table stores a correspondence between time and the preset azimuth angle and the preset elevation angle. The preset table may be constructed based on historical experience or actual demand.

More descriptions regarding how to control an opening-closing state, an azimuth angle, and an elevation angle of the solar panels and how to determine a solar power generation amount of the plurality of solar panels may be found elsewhere in the present disclosure (e.g., FIG. 3 and related descriptions thereof).

The drive motor may include one or more servo motors, stepper motors, hydraulic actuators, or pneumatic actuators, and a corresponding transmission mechanism (e.g., a gear reducer or a worm gear mechanism). Exemplarily, the photovoltaic power generation module 4 may be equipped with a multi-axis drive system, a first drive motor is configured to adjust the elevation angle of the solar panels about a horizontal axis, a second drive motor is configured to adjust the azimuth angle of the solar panels about a vertical axis, and a third drive mechanism is configured to control the folding and closing of the plurality of solar panels under extreme sea state conditions and the unfolding thereof under calm sea state conditions.

In some embodiments, the wind power generation module 5 may include a helical generator, and the helical generator is configured to perform wind power generation to obtain wind energy.

In some embodiments, the helical generator may also be referred to as a vertical helical wind turbine. In some embodiments, more descriptions regarding a working process of the wind power generation module 5 and how to determine a wind power generation amount of the wind power generation module 5 may be found elsewhere in the present disclosure (e.g., FIG. 3 and related descriptions thereof).

The helical generator refers to a wind power generation device whose a main rotor shaft is installed substantially perpendicular to a horizontal plane.

In some embodiments, the wave power generation module 6 may include a steel disc and two annular permanent magnets connected by a spring telescopic rod and a central rigid shaft. In some embodiments, the steel disc moves between the two annular permanent magnets, and the steel disc is configured to float up and down with wave oscillations, convert kinetic energy of waves into mechanical energy, and generate electric current through electromagnetic induction to obtain wave energy. In some embodiments, more descriptions regarding a working process of the wave power generation module 6 and how to determine a wave power generation amount of the wave power generation module 6 may be found elsewhere in the present disclosure (e.g., FIG. 3 and related descriptions thereof).

In some embodiments, the energy storage module 8 is configured to store solar energy, wind energy, and wave energy.

The energy storage module 8 may employ chemical energy storage, physical energy storage, or a combination thereof. Exemplarily, the energy storage module 8 may include, but is not limited to, a lithium-ion battery pack, a lead-carbon battery, a flow battery, a supercapacitor, or a flywheel energy storage device.

The solar energy refers to solar electromagnetic radiation energy received and converted by the photovoltaic power generation module 4. The wind energy refers to atmospheric flow kinetic energy captured by the wind power generation module 5. The wave energy refers to sea surface fluctuation energy (including potential energy and kinetic energy) absorbed by the wave power generation module 6.

In some embodiments, the intelligent dispatching module 7 is configured to control the buoyancy adjustment module 3 to activate or release the protection mode according to environmental data collected in real time, and to switch or synergistically operate the photovoltaic power generation module 4, the wind power generation module 5, and the wave power generation module 6 according to the protection mode of the buoyancy adjustment module 3.

The protection mode refers to a highly secure defense state that the device 100 enters when detecting that the current environmental data satisfies a preset extreme sea state condition, in order to prevent damage to mechanical structures, sensors, or circuit systems. More descriptions regarding activation of the protection mode may be found elsewhere in the present disclosure (e.g., FIG. 3 and related descriptions thereof).

According to some embodiments of the present disclosure, the wind-solar-wave synergistic dispatchable power generation device achieves maximization of environmental resource utilization by integrating the plurality of renewable energy power generation modules and the intelligent dispatching module 7. In some embodiments, the device 100 collects environmental data (including key information such as wind speed, wind direction, illumination intensity, wave height, wave frequency) in real time through the sensor module 2 and transmits the environmental data to the intelligent dispatching module 7 for subsequent analysis and decision-making.

In some embodiments, the energy storage module 8 is responsible for storing electric energy generated by the photovoltaic power generation module 4, the wind power generation module 5, and the wave power generation module 6. When the grid demand or energy storage level reaches a set threshold, the intelligent dispatching module 7 automatically switches or synergistically operates various power generation modules based on environmental data monitored in real time and the energy storage status, to achieve maximization of energy utilization and stable operation of the system. More descriptions regarding this section may be found elsewhere in the present disclosure (e.g., FIG. 3 and related descriptions thereof).

The energy storage status refers to physical indicators of the energy storage module 8. In some embodiments, the energy storage status may include a state of charge (SOC), a state of health (SOH), a charge-discharge current, an internal temperature of a battery pack, or the like. Exemplarily, when the intelligent dispatching module 7 monitors that the SOC is below a preset warning lower limit (e.g., 20%), the intelligent dispatching module 7 may actively reduce or cut off power supply to non-core equipment (e.g., unnecessary communication frequency or auxiliary lighting).

The wind-solar-wave synergistic dispatchable power generation device provided in some embodiments of the present disclosure can efficiently utilize renewable energy, and is capable of fully utilizing wind energy, solar energy, and wave energy by integrating a plurality of renewable energy power generation modules to achieve maximization of energy utilization. The intelligent dispatching module may automatically adjust the working states of the various power generation modules based on environmental data collected in real time, to effectively respond to energy fluctuations and grid demand changes and improve system stability and reliability. The design of the buoyancy adjustment module 3 allows the device to automatically adjust its buoyancy status according to environmental conditions, protecting the device from damage caused by extreme weather conditions, and enhancing the environmental adaptability of the system. Additionally, by optimizing energy configuration and dispatching strategies, the device is capable of reducing per-kilowatt-hour cost and improving economic benefits.

In some embodiments, the sensor module 2 is configured to collect marine environmental data in real time and comprehensively, thereby providing a decision basis for the intelligent dispatching module 7.

In some embodiments, the wave height gauge is configured to monitor the wave height and the wave frequency through a high-precision sensor, thereby providing key parameters for the wave power generation module 6 and facilitating the intelligent dispatching module 7 to predict and respond to variations in the wave energy.

In some embodiments, the illumination sensor is installed above the sea surface or on a top of the housing 1, and is configured to monitor the illumination intensity, to guide the adjustment of the opening-closing state, the azimuth angle, and the elevation angle of the plurality of solar panels of the photovoltaic power generation module 4, thereby maximizing the capture efficiency of the solar energy.

In some embodiments, the wind sensor is configured to obtain the wind speed and the wind direction data through a rotary or ultrasonic sensor, thereby providing real-time wind condition information for the wind power generation module 5 and facilitating the intelligent dispatching module 7 to optimize a wind energy utilization strategy. In some embodiments, the wind sensor may also be referred to as a wind speed and wind direction sensor.

In some embodiments, the meteorological sensor is configured to comprehensively collect meteorological data including a temperature, a humidity, and a precipitation. The meteorological data not only affects the power generation efficiency of the photovoltaic power generation module 4 and the wind power generation module 5, but also serves as an important basis for the intelligent dispatching module 7 to determine a target control strategy. More descriptions regarding the target control strategy may be found elsewhere in the present disclosure (e.g., FIG. 3 and related descriptions thereof).

In some embodiments, the attitude sensor is configured to collect the inclination angle and the attitude depth of the housing 1 through sensors such as a gyroscope or an accelerometer, thereby facilitating the intelligent dispatching module 7 to monitor the status of the device 100 and ensuring the safe operation of the device 100 in a complex marine environment.

In some embodiments, the pose sensor is configured to collect a variation range of the motion amplitude, a variation range of the yaw angle, and a variation range of the elevation angle of the housing 1 at the submergence position, thereby providing accurate position and attitude information for the intelligent dispatching module 7, to optimize the power generation efficiency and protect the safety of the device 100.

In some embodiments, the acceleration sensor is configured to obtain the vertical displacement by measuring the acceleration variation data of the housing 1, thereby facilitating the intelligent dispatching module 7 to activate the protection mode in a timely manner under extreme weather conditions and preventing the device 100 from being damaged.

In some embodiments, the depth sensor is configured to monitor the submergence depth of the housing 1 in real time, thereby ensuring that the device 100 operates within a set safe depth range and may also be used to guide the adjustment of the buoyancy adjustment module 3 to adapt to different marine environments.

In some embodiments, the intelligent dispatching module 7 may comprehensively evaluate, based on the environmental data collected by the sensor module 2, current environmental conditions and energy demand, and automatically switch or synergistically operate the photovoltaic power generation module 4, the wind power generation module 5, and the wave power generation module 6, thereby achieving the maximization of energy utilization and stable operation of the system.

One or more embodiments of the present disclosure also provide a wind-solar-wave synergistic dispatchable power generation method, which achieves complementarity and optimized dispatching among three types of renewable energy sources through an advanced control module, and addresses problems of complementarity and synergy of power generation methods existing in the prior art.

FIG. 2 is a flowchart illustrating an exemplary process of a wind-solar-wave synergistic dispatchable power generation method according to some embodiments of the present disclosure.

In some embodiments, as shown in FIG. 2, a process 200 of the wind-solar-wave synergistic dispatchable power generation method may include steps A to D. In some embodiments, the process 200 may be performed by the processor.

Step A, collecting the environmental data in real time through the sensor module 2.

More descriptions regarding the sensor module and the environmental data may be found elsewhere in the present disclosure (e.g., FIG. 1 and related descriptions thereof).

Step B, determining a current sea state based on the environmental data collected in real time, performing, by the intelligent dispatching module 7, intelligent switching or synergistic operation of the photovoltaic power generation module 4, the wind power generation module 5, and the wave power generation module 6 based on the current sea state, and storing generated solar energy, generated wind energy, and generated wave energy into the energy storage module 8.

More descriptions regarding the solar energy, the wind energy, and the wave energy may be found elsewhere in the present disclosure (e.g., FIG. 1 and related descriptions thereof).

The current sea state refers to a level obtained after quantitative evaluation of the safety and energy acquisition potential of the marine environment in which the device 100 is located. In some embodiments, the processor (or the intelligent dispatching module 7 therein) may execute an environmental evaluation algorithm (e.g., fuzzy logic inference or a multivariate decision tree) to compare and match the environmental data collected by the sensor module 2 with a preset sea state classification data table or a mathematical model, thereby outputting the corresponding current sea state in real time. Merely by way of example, as shown in FIG. 2, the processor may classify the sea state into six sea states (i.e., a first sea state to a sixth sea state (or referred to as sea states 1-6)), and the higher the sea state, the more extreme and severe the marine environment in which the device 100 is located.

The intelligent switching refers to activating or deactivating specific power generation modules by sending an electrical signal based on the determined current sea state. For example, when the sea state rapidly changes from the first sea state to the fourth sea state, the processor switches the control flow, disconnects the grid-connected output of the photovoltaic power generation module 4 and the wind power generation module 5, and instructs the photovoltaic power generation module 4 and the wind power generation module 5 to perform mechanical retraction, and simultaneously activates a full-power operation circuit of the wave power generation module 6.

For example, when illumination is sufficient and the wind speed is moderate (e.g., the illumination intensity and the wind speed respectively satisfy a preset threshold), the intelligent dispatching module 7 may prioritize activating the photovoltaic power generation module 4 and the wind power generation module 5; and when wave energy is abundant in a sea state (e.g., the wave height satisfies a preset threshold), the engagement of the wave power generation module 6 is increased. The generated solar energy, the wind energy, and the wave energy are stored into the energy storage module 8 for subsequent use.

In some embodiments, as shown in FIG. 2, when the obtained current sea state satisfies an extreme sea state condition, the processor may also continue to perform the following steps C to D.

The extreme sea state condition refers to a set of preset critical values of environmental parameters. In some embodiments, when the environmental data collected in real time reaches or exceeds the critical values in the extreme sea state condition, the environmental data is considered to pose a risk of physical damage to the surface structures of the device 100 (e.g., photovoltaic panels, wind blades) or lead to the device 100 overturning. In some embodiments, the extreme sea state condition may include, but is not limited to, at least one of the following: the wind speed continuously exceeding a wind speed threshold (e.g., 25 m/s) for a preset duration (e.g., 30 seconds(s)); the wave height exceeding a wave height threshold (e.g., 4 meters (m)); or the inclination angle of the housing 1 exceeding a preset safe swing range (e.g., 30 degrees). In some embodiments, the extreme sea state condition may be set based on historical experience or actual needs.

Merely by way of example, when the device 100 is in extreme environments (e.g., storms, giant waves), the intelligent dispatching module 7 may immediately control the buoyancy adjustment module 3 to activate the protection mode. Under the protection mode, the photovoltaic power generation module 4 and the wind power generation module 5 are closed to prevent damage caused by extreme weather. Meanwhile, the buoyancy adjustment module 3 may adjust the housing 1 to submerge to the safe depth, thereby reducing the impact of sea waves on the device. During this period, the wave power generation module 6 may be switched to a standalone power generation operating mode, to utilize the wave energy to replenish energy for the energy storage module 8.

Step C, controlling, by the intelligent dispatching module 7, the buoyancy adjustment module 3 to activate the protection mode, closing the photovoltaic power generation module 4 and the wind power generation module 5, adjusting the housing 1 to submerge to the safe depth, simultaneously switching to the wave power generation module 6, and the wave power generation module 6 performing power generation alone.

More descriptions regarding the protection mode may be found elsewhere in the present disclosure (e.g., FIG. 1 and related descriptions thereof).

The safe depth refers to a preset depth range located below the sea surface, where a direct impact force from surface wind and waves is significantly reduced. In some embodiments, the safe depth may be set based on historical experience or actual needs.

Step D, continuously collecting the environmental data through the sensor module 2, when the environmental data satisfies a release condition, releasing, by the buoyancy adjustment module 3, the protection mode, adjusting the housing 1 to ascend to the sea surface, and the intelligent dispatching module 7 resuming a normal dispatching and power generation function.

Merely by way of example, when the environmental conditions improve (e.g., the wave height decreases, the wind speed reduces), the buoyancy adjustment module 3 may release the protection mode and adjust the housing 1 to ascend to the sea surface. At this time, the intelligent dispatching module 7 can resume the normal dispatching and power generation function and readjust the working state of the respective power generation modules based on new environmental data.

The release condition refers to a condition used to determine that the extreme sea state has ended. In some embodiments, the release condition may also be referred to as a threshold condition for releasing the extreme sea state.

In some embodiments, the release condition includes a swing amplitude less than 0.5 m, a swing duration greater than 18 s, and a swing frequency less than 0.15 Hertz (Hz).

It may be understood that the example of the above-described release conditions is merely an exemplary embodiment provided by the present disclosure and does not constitute a strict limitation on the protection scope of the present disclosure. In practical applications, a person skilled in the art may understand that the above-described various threshold conditions for releasing the extreme sea state may all be adaptively preset or dynamically adjusted based on the specific marine environmental characteristics of the area where the device 100 is deployed.

The swing amplitude refers to a displacement amplitude in a vertical or horizontal direction during wave oscillations of the device 100. In some embodiments, when the release condition includes a swing amplitude threshold less than 0.5 m, it implies that if the maximum displacement of the device 100 (from the sea surface to the highest point or the lowest point of the device 100) exceeds 0.5 m, the wave fluctuation amplitude is considered relatively large, and activation of the protection mode is required. In some embodiments, the swing amplitude of the device 100 may be obtained based on the aforementioned attitude sensor.

The swing duration refers to the duration of the periodic fluctuation of the waves. In some embodiments, when the release condition includes a swing duration threshold greater than 18 s, it implies that if the vibration or the swing of the device 100 lasts more than 18 s, the wave period may be relatively long or the fluctuation may be relatively large, which may have a continuous impact on the device 100, and therefore activation of the protection mode is required. In some embodiments, the swing duration of the device 100 may be obtained based on the aforementioned pose sensor.

The swing frequency refers to the number of occurrences per second of the vibration or the swing caused by waves, with a unit of Hz. In some embodiments, when the release condition includes a swing frequency threshold less than 0.15 Hz, it implies that the wave period is relatively long, which may have a relatively continuous impact on the device 100. Therefore, when the swing frequency exceeds 0.15 Hz, it is identified as a relatively extreme sea state, and the activation of the protection mode is required. In some embodiments, the swing frequency may be obtained based on the aforementioned pose sensor.

In some embodiments, the raw signals collected by the sensor module 2 in the marine environment are usually accompanied by a large amount of hydrodynamic noise and random high-frequency interference. To obtain high-fidelity feature data, the processor is configured to utilize a Kalman Filtering algorithm to perform optimal state estimation on noisy time series data output by the attitude sensor and the acceleration sensor.

In some embodiments, a support vector machine (SVM) model is also deployed in the processor. The processor inputs a multi-source feature vector (namely, the real-time swing amplitude, the swing duration, and the swing frequency) extracted by the aforementioned filtering and transformation algorithms at the current moment into the SVM model. When an output of the SVM model is determined as a safe state (e.g., a probability of being in a safe category exceeds a preset safety confidence), the processor may determine that the environmental data satisfies the release condition.

In some embodiments of the present disclosure, threshold conditions for the swing amplitude, the swing duration, and the swing frequency are set as the release condition based on physical characteristics and characteristics of the actual environment. Combined with the corresponding sensor signals from the sensor module 2, Kalman Filtering or Fourier transform is utilized to extract the frequency and amplitude features. A machine learning algorithm, namely SVM, is utilized to perform comprehensive analysis on multi-source data from the three conditions. When the release condition is satisfied, the protection mode is automatically released, and power generation of the solar energy and the wind energy is gradually resumed, so as to ensure the normal operation of the device 100.

According to one or more embodiments of the present disclosure, the wind-solar-wave synergistic dispatchable power generation method is specifically designed to be applied to the device 100 that integrates a plurality of renewable energy power generation modules and the intelligent dispatching module 7. The different power generation modules can be intelligently switched or synergistically operated based on the real-time collected environmental data, so as to maximize energy utilization efficiency and ensure safe operation of the device.

In some embodiments of the present disclosure, by utilizing the real-time collected environmental data and an intelligent dispatching strategy, the power generation modules can be intelligently switched or synergistically operated according to the different sea state conditions, so as to achieve maximized energy utilization. In extreme sea state conditions, by activating the protection mode and adjusting the submergence depth of the housing, the power generation device can be effectively protected from damage, thereby extending the service life of the device. The entire dispatching and power generation process is highly automated, which reduces manual intervention and operation and maintenance costs, thereby improving the economic efficiency and sustainability of the system. Furthermore, the device is applicable to a plurality of marine environmental conditions and can flexibly adjust its working state according to the actual situation, thereby having strong environmental adaptability.

FIG. 3 is a schematic diagram illustrating an exemplary process for determining the target control strategy according to some embodiments of the present disclosure.

In some embodiments, as shown in FIG. 3, when the current sea state is determined based on real-time collected environmental data, and the intelligent dispatching module 7 performs intelligent switching or synergistic operation of the photovoltaic power generation module 4, the wind power generation module 5, and the wave power generation module 6, the processor may be configured to: determine the target control strategy based on the current sea state, the wave height, the wind speed, and the illumination intensity. The target control strategy includes an activation state of the protection mode, an activation state of the photovoltaic power generation module, an activation state of the wind power generation module, and an activation state of the wave power generation module. The wave height is obtained by the wave height gauge; the wind speed is obtained by the wind sensor; and the illumination intensity is obtained by the illumination sensor.

More descriptions regarding the current sea state may be found elsewhere in the present disclosure (e.g., FIG. 2 and related descriptions thereof). More descriptions regarding the wave height, the wind speed, the illumination intensity, and the protection mode may be found elsewhere in the present disclosure (e.g., FIG. 1 and related descriptions thereof).

The target control strategy refers to a set of multi-variable synergistic operation instructions. The activation state refers to a physical operating mode and an electrical connection state of the various power generation modules in the device 100. In some embodiments, the activation state may include “activation” and “deactivation” of the modules. Merely by way of example, when the activation state of the photovoltaic power generation module 4 is “activation”, the photovoltaic power generation module 4 unfolds the plurality of solar panels through the drive motor and performs photovoltaic power generation to obtain solar energy.

In some embodiments, when determining the target control strategy based on the current sea state, the wave height, the wind speed, and the illumination intensity, the processor may be configured to: when the sea state is a first sea state, the wave height is less than 0.5 m, the wind speed is less than 12.6 km/h, and the illumination intensity is less than 100 W/m², determine the target control strategy to be activating the wind energy and the wave energy; and when the sea state is the first sea state, the wave height is less than 0.5 m, the wind speed is less than 12.6 km/h, and the illumination intensity is greater than or equal to 100 W/m², determine the target control strategy to be activating the solar energy, the wind energy, and the wave energy. In some embodiments, when activating the solar energy, the processor instructs the drive motor of the photovoltaic power generation module 4 to drive the plurality of solar panels to unfold from a folded or stacked state to a flat state, to receive solar radiation for photovoltaic power generation to obtain solar energy.

In some embodiments, when activating the wind energy, the processor may release an electromagnetic braking device of the helical generator of the wind power generation module 5, thereby causing the blades of the helical generator to start rotating under wind drive for wind power generation. In some embodiments, when activating the wave energy, the processor may switch a circuit of the wave power generation module 6 to an operating state, causing the vertical displacement of the steel disc generated by wave oscillations to start cutting the magnetic induction lines through the central rigid shaft, thereby converting the kinetic energy of the waves into electric energy.

In some embodiments of the present disclosure, setting the preset intensity threshold of 100 W/m² can serve as a determination boundary for “false activation prevention” of the photovoltaic power generation module, effectively preventing the device from blindly activating the photovoltaic components and frequently driving the drive motor when the illumination is too weak (e.g., at late night or in heavy fog weather), thereby reducing internal power consumption of the system. Meanwhile, precisely quantifying a physical boundary of the first sea state allows the device to fully activate the solar energy, the wind energy, and the wave power generation modules without delay when environmental resources are optimal, thereby maximizing a net power generation amount and an energy storage efficiency of the system.

In some embodiments, as shown in FIG. 3, when the current sea state is a first sea state, the device 100 may mainly utilize photovoltaic power generation, supplemented by wind power generation, that is, the processor is configured to preferentially activate the photovoltaic power generation module 4.

In some embodiments, when determining the target control strategy based on the current sea state, the wave height, the wind speed, and the illumination intensity, the processor may be configured to: when the sea state is a second sea state, the wave height is greater than or equal to 0.5 m but less than 1.0 m, the wind speed is greater than or equal to 12.6 km/h but less than 25.2 km/h, and the illumination intensity is less than 100 W/m², determine the target control strategy to be activating the wind energy and the wave energy; and when the sea state is the second sea state, the wave height is greater than or equal to 0.5 m but less than 1.0 m, the wind speed is greater than or equal to 12.6 km/h but less than 25.2 km/h, and the illumination intensity is greater than or equal to 100 W/m², determine the target control strategy to be activating the solar energy, the wind energy, and the wave energy.

In some embodiments of the present disclosure, by identifying variations in the environmental data and automatically switching the power generation modules, the device can ensure that core control resources are concentrated at the energy source with the highest energy density (e.g., wind energy or wave energy) at any time. This flexible dispatching mechanism not only overcomes the drawback of large fluctuations of a single energy source due to meteorological influences, but also effectively reduces overall mechanical stress and fatigue damage of the device in strong wind and wave environments by dynamically allocating the activation states of the various modules, thereby extending an offshore operational life.

In some embodiments, as shown in FIG. 3, when the current sea state is a second sea state, the device 100 may mainly utilize wind power generation, supplemented by wave power generation, that is, the processor is configured to preferentially activate the wind power generation module 5 for power generation.

In some embodiments, when determining the target control strategy based on the current sea state, the wave height, the wind speed, and the illumination intensity, the processor may be configured to: when the sea state is a third sea state, the wave height is greater than or equal to 1.0 m but less than 2.0 m, and the wind speed is greater than or equal to 25.2 km/h but less than 36 km/h, determine the target control strategy to be activating the wind energy and the wave energy and synergistically operating the solar energy; when the sea state is a fourth sea state, the wave height is greater than or equal to 2.0 m but less than 4.0 m, and the wind speed is greater than or equal to 36 km/h but less than 54 km/h, determine the target control strategy to be activating the protection mode and activating only the wave energy; when the sea state is a fifth sea state, the wave height is greater than or equal to 4.0 m but less than 6.0 m, and the wind speed is greater than or equal to 54 km/h but less than 72 km/h, determine the target control strategy to be activating the protection mode and activating only the wave energy; and when the sea state is a sixth sea state, the wave height is greater than 6.0 m, and the wind speed is greater than 72 km/h, determine the target control strategy to be activating the protection mode and stopping power generation.

In some embodiments, as shown in FIG. 3, when the current sea state is a third sea state, the device 100 may mainly utilize wind power generation and wave power generation, that is, the processor is configured to preferentially activate the wind power generation module 5 and the wave power generation module 6.

In some embodiments, when the current sea state reaches an extreme level (e.g., a fourth sea state or a fifth sea state), the solar panels are automatically retracted, and operation of the vertical helical wind generator is stopped to prevent damage. At this time, power generation mainly relies on the wave power generation module 6. At this time, wave power generation becomes a main energy source, and the device 100 is controlled by the buoyancy adjustment module 3 to submerge to the safe depth, to reduce an impact of wind and waves on the wind-solar-wave synergistic power generation device.

In some embodiments, under a third sea state, by adjusting a synergistic operating state of the solar energy components, the device can preliminarily reduce wind loads on a sea surface structure while maintaining a high-power output. When the sea state further deteriorates to a fourth sea state and a fifth sea state, the device can actively submerge to the safe depth, utilizing a hydrodynamic characteristic that wave energy rapidly decays with increasing water depth, thereby causing the high-positioned wind and photovoltaic components to completely detach from direct mechanical impact of sea surface breaking waves, achieving a technical leap from passive wave resistance to active wave avoidance. The measure of completely stopping power generation adopted for a sixth sea state of extremely large extreme sea conditions exchanges instantaneous power generation capacity for extreme physical redundancy, thereby ensuring the integrity of an overall structure of the device when exceeding design limit loads.

In some embodiments, the processor may also query a preset table based on the current sea state, the wave height, the wind speed, and the illumination intensity to obtain the target control strategy. The preset table stores a correspondence relationship between the current sea state level, the wave height, the wind speed, the illumination intensity, and the target control strategy. Merely by way of example, the preset table may be represented as follows:

| | Wave | | Illumination | |
|---|---|---|---|---|
| Sea | height | Wind speed | intensity | |
| state | (m) | (km/h) | (W/m²) | Control strategy |
| 1 | <0.5 | <12.6 | <100 | Activate the wind energy and the wave |
| | | | | energy |
| | | | ≥100 | Activate the solar energy, the wind |
| | | | | energy, and the wave energy |
| 2 | 0.5-1.0 | 12.6-25.2 | <100 | Activate the wind energy and the wave |
| | | | | energy |
| | | | ≥100 | Activate the solar energy, the wind |
| | | | | energy, and the wave energy |
| 3 | 1.0-2.0 | 25.2-36 | <100 | Activate the wind energy and the wave |
| | | | | energy and synergistically operate the |
| | | | | solar energy |
| | | | ≥100 | Activate the wind energy and the wave |
| | | | | energy and synergistically operate the |
| | | | | solar energy |
| 4 | 2.0-4.0 | 36-54 | \ | Activate the protection mode and |
| | | | | activate only the wave energy |
| 5 | 4.0-6.0 | 54-72 | \ | Activate the protection mode and |
| | | | | activate only the wave energy |
| 6 | >6.0 | >72 | \ | Activate the protection mode and stop |
| | | | | power generation |

It should be understood that the specific numerical ranges of the wave height, the wind speed, and the illumination intensity corresponding to the respective sea states shown in the above table are merely an exemplary division manner provided in the present disclosure, and do not constitute a strict limitation on the protection scope of the present disclosure. In addition, the specific synergistic and switching manners of the respective power generation modules in the target control strategy may also be flexibly configured according to a real-time state of the energy storage module. Such equivalent variations or substitutions are all included within the protection scope defined by the present disclosure.

In some embodiments of the present disclosure, determining the target control strategy based on multi-dimensional environmental parameters can significantly improve system dispatching accuracy, energy conversion efficiency, and structural safety. By comprehensively utilizing specific physical characteristics such as the real-time collected wave height, the wind speed, and the illumination intensity from the wave height gauge, the wind sensor, and the illumination sensor, and cooperating with a macroscopic determination of the current sea state level, the system can establish a dual dispatching decision mechanism from macroscopic environmental identification to microscopic parameter feedback, thereby significantly improving the adaptability of the target control strategy to a complex and variable marine environment.

In some embodiments, in step B shown in FIG. 2, when the intelligent dispatching module performs intelligent switching or synergistic operation of the photovoltaic power generation module, the wind power generation module, and the wave power generation module based on the current sea state level, the photovoltaic power generation module 4 is configured to: obtain the intensity comparison result based on the illumination intensity collected in real time by the illumination sensor and the preset intensity threshold; control the drive motor to adjust an opening-closing state of a plurality of solar panels based on the intensity comparison result; in response to the intensity comparison result indicating that the illumination intensity is greater than or equal to the preset intensity threshold, control the drive motor to drive the solar panels to open for photovoltaic power generation; and in response to the intensity comparison result indicating that the illumination intensity is less than the preset intensity threshold, control the drive motor to drive the solar panels to close to protect the solar panels.

In some embodiments, during an opening process of the solar panels, the illumination sensor may continuously monitor the illumination intensity, and the processor may determine the optimal azimuth angle and the optimal elevation angle of the solar panels based on a latitude of an observation point, the solar declination, and the solar hour angle. In some embodiments, the processor may further adjust, based on the optimal azimuth angle and the optimal elevation angle, the azimuth angle and the elevation angle of the solar panels by controlling the drive motor to drive the horizontal axis and the vertical axis of the solar panels, obtain the solar power generation amount of the solar panels, and transmit the solar power generation amount to the energy storage module. The solar power generation amount of the solar panels is determined based on the first instantaneous power of the solar panels; and the first instantaneous power is determined based on the area of the solar panels, the solar power generation efficiency, and the solar irradiance. In some embodiments, the solar power generation efficiency includes a comprehensive efficiency of a panel conversion efficiency, an inverter efficiency, a temperature influence, and a dust factor.

The preset intensity threshold refers to a threshold used to determine whether current natural illumination is sufficient to support effective energy conversion by the photovoltaic power generation module 4. Merely by way of example, the preset intensity threshold may be set between 80 W/m² and 150 W/m² (e.g., 100 W/m²). In some embodiments, the preset intensity threshold may be set based on historical experience or actual demands.

The intensity comparison result refers to a result obtained after the processor logically compares the illumination intensity with the aforementioned preset intensity threshold.

The observation point refers to a location of the device 100. The latitude of the observation point refers to the latitude of the location of the device 100. Merely by way of example, if the device is deployed in the South China Sea, its latitude may be around 15° N to 22° N. In some embodiments, the processor may obtain the latitude of the observation point in real time through an integrated GPS module, or it may be manually configured by personnel and pre-stored in a system memory before the device is deployed.

The solar declination refers to an angle between the sun's rays and the Earth's equatorial plane, with a range from −23.45° to +23.45°. The solar hour angle refers to an angular distance of the sun relative to a meridian of the observation point. The solar elevation angle refers to an angle between the center of the sun and a horizon of the observation point. The solar azimuth angle refers to an angle of the sun relative to a true north direction.

In some embodiments, the processor determines the solar declination and the solar hour angle in real time based on current Greenwich Mean Time, date information, and the latitude of the observation point by utilizing a preset astronomical algorithm (e.g., a solar position algorithm (SPA)).

In some embodiments, the processor may determine the solar elevation angle θ and the solar azimuth angle A_{α} based on the following formulas (1) and (2):

$$θ = arc sin ( sin ( δ ) \cdot sin ( ϕ ) + cos ( δ ) \cdot cos ( ϕ ) \cdot cos ( H ) ) , \qquad ( 1 )$$

$${A}_{α} = arc tan ( \frac{sin ( H )}{cos ( H ) \cdot sin ( ϕ ) - tan ( δ ) \cdot cos ( ϕ )} ) . \qquad ( 2 )$$

In the formulas, θ denotes the solar elevation angle; A_{α} denotes the solar azimuth angle; φ denotes the latitude of the observation point; δ denotes the solar declination; and H denotes the solar hour angle.

The optimal azimuth angle and the optimal elevation angle of the solar panels refer to a spatial angle combination that causes sun's rays to coincide with a normal direction of the solar panels (i.e., perpendicular incidence). Merely by way of example, if the observation point is located in the Northern Hemisphere, at noon, the optimal azimuth angle may point to true south (180°). In some embodiments, to eliminate cosine losses of light incidence, the optimal azimuth angle may be set to be equal to the solar azimuth angle, and the optimal elevation angle may be set to be equal to the solar elevation angle (or its complementary angle).

In some embodiments, the processor may adjust, based on the optimal azimuth angle and the optimal elevation angle of the solar panels, the azimuth angle and the elevation angle of the solar panels by controlling the drive motor to drive the horizontal axis and the vertical axis of the solar panels, thereby aligning them with an incidence direction of the sunlight, obtain a power generation amount of the solar panels, and transmit the power generation amount to the energy storage module 8.

Merely by way of example, if the processor determines that the current solar elevation angle is 45° and the azimuth angle is 180° (true south), the processor may control the drive motor to drive a vertical axis of the solar panels to rotate to 180°, and simultaneously drive an inclination angle of a horizontal axis of the solar panels to 45°. It causes a normal of a light-receiving surface of the solar panels to always point to a sun's center, thereby ensuring that a projection of the solar irradiance on the panels reaches a maximum value.

The solar power generation amount refers to the total electrical energy generated by the photovoltaic power generation module 4 within a preset time period (e.g., a first preset time) and transmitted to the energy storage module 8. For example, the photovoltaic power generation module 4 generates 2 kWh of electrical energy within 2 hours (h).

The first instantaneous power refers to an output rate at which the solar panels convert captured light energy into electrical energy. Merely by way of example, when the illumination intensity is 1000 W/m² and the solar panels are fully deployed, the first instantaneous power may be 300 W.

The area of the solar panels refers to a sum of physical areas of photovoltaic light-receiving surfaces where the solar panels participate in power generation. The solar power generation efficiency refers to a comprehensive percentage of received radiant energy converted into effective electrical energy. The solar irradiance refers to a solar radiation power received per unit area. In some embodiments, an area of the solar panels and the solar power generation efficiency may be measured and pre-stored in a processor memory; and the solar irradiance is monitored and obtained in real time through the illumination sensor installed on a top of the housing 1.

In some embodiments, the first instantaneous power is positively correlated with an area of the solar panels, the solar power generation efficiency, and the solar irradiance. In some embodiments, the solar power generation amount is positively correlated with the first instantaneous power. Merely by way of example, the processor may respectively determine the first instantaneous power P₁(t) and the solar power generation amount E₁ based on the following formulas (3) and (4):

$${P}_{1} ( t ) = A \cdot {η}_{1} \cdot G ( t ) , \qquad ( 3 )$$

$${E}_{1} = {\int }_{t 1}^{{t}_{2}} {P}_{1} ( t ) d t = {\int }_{t 1}^{{t}_{2}} A \cdot {η}_{1} \cdot G ( t ) dt . \qquad ( 4 )$$

In the formulas, P₁(t) denotes the first instantaneous power, with a unit of W; η₁ denotes the solar power generation efficiency, with a range from 0.15 to 0.22; A denotes the area of the solar panels, with a unit of m²; G(t) denotes the solar irradiance, with a unit of W/m²; and E denotes the solar power generation amount.

In some embodiments, when the solar irradiance G(t) is relatively stable within the first preset time T₁, the solar irradiance G(t) may approximate the irradiance constant G_{avg}, and at this time, the solar power generation amount E₁ may be expressed as follows:

$${E}_{1} = A \cdot η \cdot {G}_{a v g} \cdot {T}_{1} .$$

In some embodiments, the solar irradiance G(t) being relatively stable within the preset time period T₁ may refer to a variance of the solar irradiance G(t) within the preset time period T₁ being less than a stability threshold. The stability threshold may be set based on historical experience or actual demands.

In some embodiments, the processor sets the first preset time (e.g., the past 5 minutes (min) or 10 min) as a sliding window for data sampling, performs mathematical statistics and filtering analysis (e.g., obtaining a time average value or a weighted moving average value) on a plurality of instantaneous solar irradiance obtained at high frequency by the illumination sensor within the time window, and uses the obtained average value as the irradiance constant.

In some embodiments, the photovoltaic power generation module 4 employs three solar panels to form an opening-closing state. Given that an area of a single solar panel A is 2.496 m², a panel conversion efficiency of a single solar panel η₁ is 15%, and an average solar radiation intensity of a single solar panel G (i.e., an irradiance constant) is 600 W/m², and referring to a typical daily sunshine duration on the sea surface of 8.5 h, a daily average power generation amount of the photovoltaic power generation module 4 is expected to reach 5.75 kWh.

In some embodiments of the present disclosure, by precisely controlling the opening-closing of the solar panels through the preset illumination intensity threshold, ineffective motor power consumption under weak light conditions is effectively avoided. The processor determines the optimal azimuth angle and the elevation angle in real time based on astronomical parameters (e.g., latitude, solar declination, solar hour angle), thereby realizing high-precision dual-axis dynamic tracking, completely eliminating cosine losses of the fixed solar panels, and maximizing a capture rate of instantaneous light energy.

In some embodiments, in step B shown in FIG. 2, when the intelligent dispatching module performs intelligent switching or synergistic operation of the photovoltaic power generation module, the wind power generation module, and the wave power generation module based on the current sea state level, the wind power generation module 5 is configured such that: blades of the helical generator rotate with wind force, the blades are connected to a rotor of the helical generator through a main shaft to drive the rotor to rotate to produce mechanical energy, the mechanical energy is then converted into electrical energy and transmitted to the energy storage module 8.

In some embodiments, the processor may determine the wind power generation amount of the wind power generation module based on the second instantaneous power of the wind power generation module; and determine the second instantaneous power based on the air density, the swept area of the blades, the instantaneous wind speed, the wind energy conversion coefficient, and the wind power generation efficiency. The swept area is determined based on the wind turbine height and the wind turbine diameter; and the wind power generation efficiency includes a generator efficiency and a transmission efficiency.

The wind power generation amount refers to the total accumulated electrical energy generated by the wind power generation module 5 within a preset time period and successfully transmitted to the energy storage module 8.

The second instantaneous power refers to a real-time output rate at which the wind power generation module 5 converts captured air kinetic energy into effective electrical energy.

The swept area of the blades refers to a maximum frontal projection area that intercepts air flow during rotation of the helical generator. The instantaneous wind speed refers to an air fluid velocity flowing through the sea area where the device 100 is located at the current moment. In some embodiments, the swept area, as an inherent structural constant of the device 100, may be pre-stored in the processor, while the instantaneous wind speed may be collected in real time by a wind sensor installed on the top of the housing 1 and transmitted to the processor.

In some embodiments, the swept area of the blades may be expressed as a product of the wind turbine height and the wind turbine diameter.

The wind turbine height refers to an effective physical length of the helical blades along a vertical axial direction. The wind turbine diameter refers to a maximum cylindrical cross-sectional width formed when the blades rotate. The wind turbine height and the wind turbine diameter may be pre-stored in the processor as inherent structural constants of the device 100.

The wind energy conversion coefficient refers to an aerodynamic efficiency at which the helical blades convert the air kinetic energy into mechanical shaft power. The wind power generation efficiency refers to a comprehensive loss ratio jointly determined by an electromagnetic efficiency of a generator converting the mechanical energy into the electrical energy and a mechanical transmission efficiency of a main shaft transmission system (e.g., the comprehensive efficiency is 85%). In some embodiments, the wind energy conversion coefficient and the wind power generation efficiency may be pre-measured and stored in the processor.

In some embodiments, the second instantaneous power is positively correlated with the air density, the swept area of the blades, the instantaneous wind speed, the wind energy conversion coefficient, and the wind power generation efficiency. In some embodiments, the wind power generation amount and the second instantaneous power are positively correlated. By way of example, the processor may determine the second instantaneous power P₂(t) and the wind power generation amount E₂ based on the following formulas (5) and (6), respectively:

$${P}_{2} ( t ) = 0.5 \cdot {ρ}_{a i r} \cdot {A}_{w i n d} \cdot {{v}_{w i n d} ( t )}^{3} \cdot {C}_{p} \cdot {η}_{2} , \qquad ( 5 )$$

$${E}_{2} = {\int }_{t 1}^{{t}_{2}} {P}_{2} ( t ) dt = {\int }_{t 1}^{{t}_{2}} 0.5 \cdot {ρ}_{a i r} \cdot {A}_{w i n d} \cdot {{v}_{w i n d} ( t )}^{3} \cdot {C}_{p} \cdot {η}_{2} dt . \qquad ( 6 )$$

In the formulas, P₂(t) denotes the second instantaneous power with a unit of W; ρₐᵢᵣ denotes the air density, with a unit of kg/m³; A_{wind} denotes the swept area of the blades, with a unit of m²; ν_{wind}(t) denotes the instantaneous wind speed, with a unit of m/s; Cₚ denotes a power coefficient for converting the wind energy into the mechanical energy, with a value ranging from 0.3 to 0.4; 12 denotes the wind power generation efficiency, with a value ranging from 0.8 to 0.9; and E₂ denotes the wind power generation amount.

In some embodiments, when the wind speed ν_{wind}(t) is constant as a wind speed constant v_{1,avg} within a second preset time T₂, the wind power generation amount E₂ may be expressed as follows:

$${E}_{2} = 0.5 \cdot {ρ}_{a i r} \cdot {A}_{w i n d} \cdot {v}_{1 , a v g}^{{}_{3}} \cdot {C}_{p} \cdot {η}_{2} \cdot {T}_{2} .$$

In some embodiments of the present disclosure, by introducing rigorous aerodynamic and mechanical dynamic parameters such as the air density, the swept area of the blades, and the wind energy conversion coefficient, the processor can overcome a traditional limitation of merely relying on the wind speed for rough startup and shutdown, thereby establishing a high-fidelity real-time wind energy capacity calculation model. This refined modeling not only allows the intelligent dispatching module to accurately evaluate mechanical impacts and power generation potential caused by instantaneous gusts, but also provides highly valuable power baseline data for synergistic grid connection of wind, solar, and wave multi-source energy at a system level, ultimately ensuring stable mechanical operation and efficient electrical energy output of the device under complex sea wind disturbances.

In some embodiments, in the step B shown in FIG. 2, when the intelligent dispatching module performs intelligent switching or synergistic operation of the photovoltaic power generation module, the wind power generation module, and the wave power generation module based on the current sea state level, the wave power generation module 6 is configured such that: under continuous action of the waves, the steel disc drives the central rigid shaft and the coils at both ends of the central rigid shaft to move up and down, and the coils cut the magnetic induction lines and induce electric current under a varying magnetic field of the two annular permanent magnets, and the wave power generation amount of the wave power generation module 6 is transmitted to the energy storage module 8.

In some embodiments, determining the wave power generation amount of the wave power generation module includes: defining wave motion as simple harmonic motion, and obtaining the wave height and the wave period; determining the relative velocity of the wave motion based on the wave height and the wave period; determining the average velocity of the wave motion based on the wave amplitude; determining the instantaneous value of the induced electromotive force based on the relative velocity, the magnetic induction intensity, and the effective coil length; determining the total electromotive force of the coils based on the instantaneous value of the induced electromotive force and the number of coil turns; determining the third instantaneous power of the wave power generation module based on the total electromotive force and the induced current; and since the third instantaneous power changes over time, determining the average value of the third instantaneous power based on the average velocity of the wave motion to determine the wave power generation amount of the wave power generation module.

More descriptions regarding the wave height may be found elsewhere in the present disclosure (e.g., FIG. 1 and related descriptions thereof).

The wave power generation amount refers to a total accumulated electrical energy that the wave power generation module 6 converts from the captured mechanical energy of the seawater fluctuating up and down into electrical energy within a preset power generation time and effectively transmits to the energy storage module 8.

The wave period refers to a time interval experienced when the two adjacent wave crests or troughs pass through the same fixed reference point. The wave amplitude refers to a maximum vertical displacement of a water particle on the sea surface from the still water surface. In some embodiments, the wave period is obtained by the wave height gauge of the sensor module 2. In some embodiments, the wave amplitude may be expressed as one-half of the wave height.

The relative velocity of wave motion refers to the instantaneous linear velocity at which a floating component driven by the waves (e.g., a mover including permanent magnets) reciprocates along the vertical axis relative to a fixed reference component inside the system (e.g., a stator guide rod including the coils). The average velocity refers to an average rate of motion of the floating component mentioned above in a vertical direction within a complete wave period. For example, under a sea state with a wave height of 2.0 m and a period of 6 s, the floating component completes one complete up-and-down stroke (4 m), and the average velocity thereof is about 0.67 m/s.

The magnetic induction intensity refers to a spatial magnetic field strength generated by the permanent magnet array inside the wave power generation module in a working air gap, with a unit of Tesla (T). The effective coil length refers to a length of a straight conductor in a single-turn stator winding that is perpendicular to the direction of magnetic field lines and actually cuts the magnetic induction lines. The number of coil turns refers to the total number of coils connected in series in the generator stator winding.

The instantaneous value of induced electromotive force refers to the voltage generated by a single-turn coil cutting the magnetic induction lines. The total electromotive force of the coils refers to a total instantaneous voltage generated by the superposition of all series-connected coils.

The induced current refers to a directed charge flow driven and generated by the aforementioned total electromotive force in a closed wave power generation circuit. In some embodiments, the processor is configured to collect the induced current in real time through a high-precision current sensor (e.g., a Hall current sensor) connected in series with a circuit.

The third instantaneous power refers to an output rate at which the wave power generation module 6 converts the wave mechanical energy into effective electrical energy at a specific physical moment.

In some embodiments, defining wave motion as simple harmonic motion, the relative velocity of wave motion is positively correlated with the wave height and negatively correlated with the wave period. In some embodiments, the average velocity of wave motion is positively correlated with the wave amplitude and negatively correlated with the wave period. For example, the processor may respectively determine the relative velocity of wave motion v_{wave}(t) and the average velocity v_{2,avg} based on the following formulas (7) and (8):

$${v}_{w a v e} ( t ) = {A}_{w a v e} \cdot ω \cdot cos ( ω t ) = \frac{{H}_{s}}{2} \cdot \frac{2 π}{{T}_{w}} \cdot cos ( ω t ) , \qquad ( 7 )$$

$${v}_{2 , a v g} = \frac{A \cdot ω}{\sqrt{2}} = \frac{A \cdot 2 π}{\sqrt{2} \cdot {T}_{w}} = \frac{{H}_{s} \cdot π}{\sqrt{2} \cdot {T}_{w}} . \qquad ( 8 )$$

In the formulas,

$${A}_{w a v e} = \frac{{H}_{s}}{2}$$

denotes the wave amplitude, with a unit of m;

$$ω = \frac{2 π}{{T}_{w}}$$

denotes the angular frequency, with a unit of rad/s; T_{w} denotes the wave period, with a unit of s; and Hₛ denotes the wave height, with a unit of m.

In some embodiments, the instantaneous value of induced electromotive force is positively correlated with the magnetic induction intensity, the effective coil length, and the relative velocity of wave motion. In some embodiments, the total electromotive force of the coils is positively correlated with the instantaneous value of induced electromotive force and the number of coil turns. In some embodiments, the third instantaneous power is positively correlated with the total electromotive force of the coils and the induced current. For example, the processor may respectively determine the instantaneous value of induced electromotive force ε(t), the total electromotive force of the coils εₜₒₜₐₗ(t), and the third instantaneous power P₃(t) based on the following formulas (9)-(11):

$$ε ( t ) = B \cdot L \cdot {v}_{w a v e} ( t ) , \qquad ( 9 )$$

$${ε}_{total} ( t ) = N \cdot ε ( t ) = N \cdot B \cdot L \cdot {v}_{w a v e} ( t ) , \qquad ( 10 )$$

$${P}_{3} ( t ) = {ε}_{total} ( t ) \cdot I . \qquad ( 11 )$$

In the formulas, B denotes the magnetic induction intensity, with a unit of T; N denotes the number of coil turns; L denotes the effective coil length, with a unit of m; and I denotes the induced current, with a unit of A.

In some embodiments, since the third instantaneous power changes over time, the processor may determine the average value P_{avg} of the third instantaneous power to determine the wave power generation amount. In some embodiments, the average value P_{avg} of the third instantaneous power may be expressed as follows:

$${P}_{a v g} = \frac{1}{T} {\int }_{0}^{T} {P}_{3} ( t ) dt = \frac{1}{T} {\int }_{0}^{T} N \cdot B \cdot L \cdot {v}_{w a v e} ( t ) \cdot Idt .$$

In some embodiments,

$$\frac{1}{T} {\int }_{0}^{T} {v}_{w a v e} ( t ) dt$$

may be approximated as the average velocity v_{2,avg} of wave motion, thus the average value P_{avg} of the third instantaneous power may be expressed as follows:

$${P}_{a v g} = N \cdot B \cdot L \cdot {v}_{2 , a v g} \cdot I .$$

Combining the aforementioned formula (8), the average value P_{avg} of the third instantaneous power may finally be expressed as follows:

$${P}_{a v g} = N \cdot B \cdot L \cdot \frac{Hs \cdot π}{\sqrt{2} \cdot {T}_{w}} \cdot I .$$

In some embodiments, the wave power generation amount E₃ may be represented as the product of the average value P_{avg} of the third instantaneous power and the power generation time T₃, which is expressed as follows:

$${E}_{3} = {P}_{a v g} \cdot {T}_{3} .$$

The power generation time refers to a time interval from being activated to being shut down.

In some embodiments, the wave power generation module 6 is capable of efficiently capturing and utilizing wave energy through a carefully designed mechanical structure and an electromagnetic conversion principle. In the structural design of an offshore device, compared to photovoltaic power generation and wind power generation, wave power generation has a higher energy density and a more stable energy output. Furthermore, by introducing rigorous electromagnetic induction dynamic parameters such as the relative velocity of wave motion, the magnetic induction intensity, the number of coil turns, the system builts a high-precision linear generator output model at a logical bottom layer, thereby providing an extremely robust and reliable bottom-layer power guarantee for maintaining the operation of the core control system, executing floating-up commands, or the like.

In some embodiments, when the obtained current sea state data satisfies the extreme sea state condition, the intelligent dispatching module controls the buoyancy adjustment module to activate the protection mode, closes the photovoltaic power generation module and the wind power generation module, and adjusts the housing to submerge to a safe depth, and the processor is configured to: monitor the submergence depth of the housing 1 in real time through the depth sensor; automatically adjust, by the intelligent dispatching module 7, the water storage volume of the water storage compartment based on the submergence depth, so that the buoyancy of the housing 1 is balanced with the weight to maintain the safe depth; determine the buoyancy of the housing based on the seawater density, the water storage volume of the water storage compartment, and the gravitational acceleration; determine the tension of the anchor chain based on the lever arm between the buoyancy center and the anchor chain point and the housing weight; determine the water storage volume of the water storage compartment based on the buoyancy of the housing and the housing weight; and adjust the submergence depth of the housing based on the tension of the anchor chain and the water storage volume.

More descriptions regarding the safe depth may be found elsewhere in the present disclosure (e.g., FIG. 2 and related descriptions thereof).

The water storage volume of the water storage compartment refers to a volume or mass of seawater contained in a ballast tank inside the buoyancy adjustment module 3. In some embodiments, the processor is configured to monitor a water level in real time through a liquid level sensor installed in the water storage compartment, or cumulatively determine an inlet/outlet water volume through a high-precision flow meter on an inlet/drainage pipeline.

The tension of an anchor chain refers to a tensile stress borne by mechanical anchor chain points connecting various moving components of the device 100 (e.g., the housing and a buoy, or the device 100 and a seabed mooring system). Merely by way of example, when the housing 1 generates a huge residual buoyancy, the buoyancy may be converted into an upward pulling force on the anchor chain connected to the bottom. In some embodiments, a strain gauge or a pressure sensor may be integrated at anchor chain bolts or connecting pins, which is configured to monitor the tension of the anchor chain in real time and transmit the tension to the processor.

The lever arm refers to a vertical distance between the centerline of buoyancy and the pivot point of the anchor chain. Merely by way of example, when the device 100 is inclined, a length of the lever arm may vary with an attitude, thereby changing a magnitude of a torque on the anchor chain. In some embodiments, based on preset geometric structural constants of the device and the inclination angle fed back by the attitude sensor (e.g., a gyroscope), the length of the lever arm may be determined by the processor through geometric trigonometric functions.

The buoyancy of the housing refers to an upward acting force generated by seawater on the housing 1 and its attached submerged components.

In some embodiments, the buoyancy of the housing 1 has a positive correlation with a seawater density, the water storage volume of the water storage compartment, and a gravitational acceleration. Merely by way of example, the processor may determine the buoyancy of the housing F_{b} based on the following formula (12):

$${F}_{b} = {ρ}_{s e a} \cdot {V}_{water} \cdot g . \qquad ( 12 )$$

In the formula, F_{b} denotes the buoyancy of the housing 1; ρₛₑₐ denotes a seawater density; V_{water} denotes the water storage volume of the water storage compartment; and g denotes a gravitational acceleration.

In some embodiments, to achieve precise control of the submergence depth of the housing 1, the intelligent dispatching module 7 (or the processor) is configured to dynamically determine the water storage volume of the water storage compartment based on a mechanical equilibrium model (the following formulas (13) to (16)). The dynamic determination of the target water storage volume by the processor based on the mechanical equilibrium model may be as follows:

The tension of the anchor chain is determined based on a physical moment or a force conversion relationship, that is, the above-mentioned tension of the anchor chain T_{hinge} is equal to a product of the buoyancy of the housing F_{b} and the lever arm d between the center of buoyancy and the anchor chain point, which is expressed as follows:

$${T}_{h i n g e} = {F}_{b} \cdot d . \qquad ( 13 )$$

Based on a vertical static force equilibrium condition of the device underwater, the current buoyancy of the housing is determined, that is, the buoyancy of the housing F_{b} is equal to a sum of a housing weight F_{g} and the above-mentioned determined tension of the anchor chain T_{hinge}, which is expressed as follows:

$${F}_{b} = {F}_{g} + {T}_{h i n g e} . \qquad ( 14 )$$

According to Archimedes' principle of buoyancy, when the system is in a stable suspension or submergence equilibrium state, the weight of seawater displaced by the device (i.e., a product of the seawater density ρₛₑₐ, the water storage volume of the water storage compartment V_{water}, and the gravitational acceleration g) is equal to the housing weight (i.e., a product of a mass of the housing m_{device} and the gravitational acceleration g):

$${ρ}_{s e a} \cdot {V}_{water} \cdot g = {m}_{d e v i c e} \cdot g , \qquad ( 15 )$$

$${V}_{water} = \frac{{m}_{d e v i c e}}{{ρ}_{s e a}} . \qquad ( 16 )$$

In some embodiments, the processor may perform algebraic derivation based on the above-mentioned mechanical equilibrium model to determine the water storage volume V_{water} inside the water storage compartment required to maintain the current attitude. The intelligent dispatching module 7 subsequently converts the calculation result into driving instructions and controls an inlet/outlet pump assembly of the buoyancy adjustment module 3 to perform precise water injection or drainage operations until the system reaches a complete force equilibrium state.

In some embodiments, when the protection mode is activated, the intelligent dispatching module 7 may instruct an inlet pump to open to increase the water storage volume of the water storage compartment, thereby causing the weight to be greater than the buoyancy, and the device starts to submerge. During this process, the processor performs dynamic determination of the water storage volume of the water storage compartment in real time, and when approaching the target depth, adjusts a drainage pump to discharge excess water, allowing the device to reach an equilibrium state of “zero buoyancy” or slightly negative buoyancy. Through this refined water pressure and counterweight adjustment, the device can maintain a suspension attitude at the target depth, avoiding continuous submergence or accidental floating.

In some embodiments of the present disclosure, by introducing the real-time monitoring of the tension of the anchor chain and the lever arm, the system can precisely grasp a mechanical load distribution of the device in a deep submergence state, thereby effectively preventing fatigue damage or structural tearing caused by excessive local force. The precise depth control avoids a most destructive breaking wave layer on the sea surface. Finally, this mechanical feedback-based autonomous buoyancy control mechanism greatly reduces the demand for manual intervention under the extreme sea states and ensures that the device has strong disaster avoidance capability and long-term survival reliability in unmanned deep and remote sea areas.

The technical principles of the present disclosure have been described above in conjunction with specific embodiments. These descriptions are merely for explaining the principles of the present disclosure and shall not be construed in any way as a limitation on the protection scope of the present disclosure. Based on the explanations herein, a person skilled in the art may readily conceive of other specific embodiments of the present disclosure without expending creative work, and these equivalent variations or substitutions are all included within the scope defined by the claims of the present disclosure.

What is claimed is:

1. A wind-solar-wave synergistic dispatchable power generation device, comprising: a housing, a sensor module, a buoyancy adjustment module, a photovoltaic power generation module, a wind power generation module, a wave power generation module, an energy storage module, and an intelligent dispatching module, wherein the sensor module, the buoyancy adjustment module, the photovoltaic power generation module, the wind power generation module, the wave power generation module, the energy storage module, and the intelligent dispatching module are installed inside the housing, wherein
the sensor module includes a plurality of sensors, wherein the plurality of sensors are configured to collect environmental data in real time, a water storage compartment is provided inside the housing, an anchor chain is connected to an exterior of the housing, and the buoyancy adjustment module is configured to automatically intake water into or drain water from the water storage compartment according to an activation state of a protection mode and adjust a tension of the anchor chain, thereby adjusting a buoyancy status of the housing;
the photovoltaic power generation module includes a plurality of solar panels, wherein the plurality of solar panels are configured to control an opening-closing state, an azimuth angle, and an elevation angle through a drive motor, and the plurality of solar panels are configured to perform photovoltaic power generation to obtain solar energy;
the wind power generation module includes a helical generator, wherein the helical generator is configured to perform wind power generation to obtain wind energy;
the wave power generation module includes a steel disc and two annular permanent magnets connected by a spring telescopic rod and a central rigid shaft, wherein the steel disc moves between the two annular permanent magnets, the steel disc is configured to float up and down with wave oscillations, convert kinetic energy of waves into mechanical energy, and generate electric current through electromagnetic induction to obtain wave energy;
the energy storage module is configured to store the solar energy, the wind energy, and the wave energy; and
the intelligent dispatching module is configured to control the buoyancy adjustment module to activate or release the protection mode according to the environmental data collected in real time, and to switch or synergistically operate the photovoltaic power generation module, the wind power generation module, and the wave power generation module according to the protection mode of the buoyancy adjustment module.

2. The device according to claim 1, wherein the sensor module includes:
a wave height gauge configured to monitor wave information including a wave height and a wave frequency;
an illumination sensor configured to monitor an illumination intensity on a sea surface;
a wind sensor configured to obtain a wind speed and wind direction data;
a meteorological sensor configured to collect meteorological data including a temperature, a humidity, and a precipitation;
an attitude sensor configured to collect an inclination angle and an attitude depth of the housing;
a pose sensor configured to collect a variation range of a motion amplitude, a variation range of a yaw angle, and a variation range of an elevation angle of the housing at a submergence position;
an acceleration sensor configured to measure acceleration variation data of the housing to obtain a vertical displacement; and
a depth sensor configured to monitor a submergence depth of the housing in real time.

3. A wind-solar-wave synergistic dispatchable power generation method, comprising:
collecting environmental data in real time through a sensor module;
determining a current sea state based on the environmental data collected in real time, performing, by an intelligent dispatching module, intelligent switching or synergistic operation of a photovoltaic power generation module, a wind power generation module, and a wave power generation module based on the current sea state, and storing generated solar energy, generated wind energy, and generated wave energy into an energy storage module;
when the current sea state satisfies an extreme sea state condition,
controlling, by the intelligent dispatching module, a buoyancy adjustment module to activate a protection mode, closing the photovoltaic power generation module and the wind power generation module, adjusting the housing to submerge to a safe depth, simultaneously switching to the wave power generation module, and the wave power generation module performing power generation alone; and
continuously collecting the environmental data through the sensor module, when the environmental data satisfies a release condition, releasing, by the buoyancy adjustment module, the protection mode, adjusting the housing to ascend to the sea surface, and the intelligent dispatching module resuming a normal dispatching and power generation function.

4. The method according to claim 3, wherein the determining the current sea state based on the environmental data collected in real time, and performing, by the intelligent dispatching module, intelligent switching or synergistic operation of the photovoltaic power generation module, the wind power generation module, and the wave power generation module based on the current sea state, includes:
determining a target control strategy based on the current sea state, a wave height, a wind speed, and an illumination intensity, wherein the target control strategy includes an activation state of the protection mode, an activation state of the photovoltaic power generation module, an activation state of the wind power generation module, and an activation state of the wave power generation module;
wherein the wave height is obtained by a wave height gauge; the wind speed is obtained by a wind sensor; and the illumination intensity is obtained by an illumination sensor.

5. The method according to claim 4, wherein the determining the target control strategy based on the current sea state, the wave height, the wind speed, and the illumination intensity includes:
when the current sea state is a first sea state, the wave height is less than 0.5 m, the wind speed is less than 12.6 km/h, and the illumination intensity is less than 100 W/m², the target control strategy being to activate the wind energy and the wave energy; and
when the current sea state is the first sea state, the wave height is less than 0.5 m, the wind speed is less than 12.6 km/h, and the illumination intensity is greater than or equal to 100 W/m², the target control strategy being to activate the solar energy, the wind energy, and the wave energy.

6. The method according to claim 4, wherein the determining the target control strategy based on the current sea state, the wave height, the wind speed, and the illumination intensity includes:
when the current sea state is a second sea state, the wave height is greater than or equal to 0.5 m but less than 1.0 m, the wind speed is greater than or equal to 12.6 km/h but less than 25.2 km/h, and the illumination intensity is less than 100 W/m², the target control strategy being to activate the wind energy and the wave energy; and
when the current sea state is the second sea state, the wave height is greater than or equal to 0.5 m but less than 1.0 m, the wind speed is greater than or equal to 12.6 km/h but less than 25.2 km/h, and the illumination intensity is greater than or equal to 100 W/m², the target control strategy being to activate the solar energy, the wind energy, and the wave energy.

7. The method according to claim 4, wherein the determining the target control strategy based on the current sea state, the wave height, the wind speed, and the illumination intensity includes:
when the current sea state is a third sea state, the wave height is greater than or equal to 1.0 m but less than 2.0 m, and the wind speed is greater than or equal to 25.2 km/h but less than 36 km/h, the target control strategy being to activate the wind energy and the wave energy and synergistically operate the solar energy;
when the current sea state is a fourth sea state, the wave height is greater than or equal to 2.0 m but less than 4.0 m, and the wind speed is greater than or equal to 36 km/h but less than 54 km/h, the target control strategy being to activate the protection mode and activate only the wave energy;
when the current sea state is a fifth sea state, the wave height is greater than or equal to 4.0 m but less than 6.0 m, and the wind speed is greater than or equal to 54 km/h but less than 72 km/h, the target control strategy being to activate the protection mode and activate only the wave energy; and
when the current sea state is a sixth sea state, the wave height is greater than 6.0 m, and the wind speed is greater than 72 km/h, the target control strategy being to activate the protection mode and stop power generation.

8. The method according to claim 4, wherein when the intelligent dispatching module performs intelligent switching or synergistic operation of the photovoltaic power generation module, the wind power generation module, and the wave power generation module based on the current sea state, a working process of the photovoltaic power generation module includes:
obtaining an intensity comparison result based on the illumination intensity collected in real time by the illumination sensor and a preset intensity threshold;
controlling a drive motor to adjust an opening-closing state of a plurality of solar panels based on the intensity comparison result;
in response to the intensity comparison result indicating that the illumination intensity is greater than or equal to the preset intensity threshold, controlling the drive motor to drive the solar panels to open for photovoltaic power generation;
in response to the intensity comparison result indicating that the illumination intensity is less than the preset intensity threshold, controlling the drive motor to drive the solar panels to close;
during an opening process of the solar panels, continuously monitoring, by the illumination sensor, the illumination intensity, and determining an optimal azimuth and an optimal elevation angle of the solar panels based on a latitude of an observation point, a solar declination, and a solar hour angle;
adjusting an azimuth and an elevation angle of the solar panels by controlling the drive motor to drive a horizontal axis and a vertical axis of the solar panels based on the optimal azimuth and the optimal elevation angle, obtaining a solar power generation amount of the solar panels, and transmitting the solar power generation amount to the energy storage module;
wherein the solar power generation amount of the solar panels is determined based on a first instantaneous power of the solar panels; and
the first instantaneous power is determined based on an area of the solar panels, a solar power generation efficiency, and a solar irradiance;
wherein the solar power generation efficiency includes a comprehensive efficiency of a panel conversion efficiency, an inverter efficiency, a temperature influence, and a dust factor.

9. The method according to claim 4, wherein when the intelligent dispatching module performs intelligent switching or synergistic operation of the photovoltaic power generation module, the wind power generation module, and the wave power generation module based on the current sea state, a working process of the wind power generation module includes:
blades of a helical generator rotating with wind force, the blades connected to a rotor of the helical generator through a main shaft driving the rotor to rotate to generate mechanical energy, and converting the mechanical energy into electrical energy and transmitting the electrical energy to the energy storage module;
determining a wind power generation amount of the wind power generation module based on a second instantaneous power of the wind power generation module; and
determining the second instantaneous power based on an air density, a swept area of the blades, an instantaneous wind speed, a wind energy conversion coefficient, and a wind power generation efficiency;
wherein the swept area is determined based on a wind turbine height and a wind turbine diameter; and the wind power generation efficiency includes a generator efficiency and a transmission efficiency.

10. The method according to claim 4, wherein when the intelligent dispatching module performs intelligent switching or synergistic operation of the photovoltaic power generation module, the wind power generation module, and the wave power generation module based on the current sea state, a working process of the wave power generation module includes:
under continuous action of waves, a steel disc driving a central rigid shaft and coils at both ends of the central rigid shaft to move up and down, and the coils cutting magnetic induction lines and inducing electric current under varying magnetic field of two annular permanent magnets; and obtaining a wave power generation amount of the wave power generation module and transmitting the wave power generation amount to the energy storage module;
wherein the wave power generation amount of the wave power generation module is determined by a process including:
defining wave motion as simple harmonic motion, and obtaining a wave height and a wave period;
determining a relative velocity of the wave motion based on the wave height and the wave period;
determining an average velocity of the wave motion based on a wave amplitude;
determining an instantaneous value of an induced electromotive force based on the relative velocity, a magnetic induction intensity, and an effective coil length;
determining a total electromotive force of the coils based on the instantaneous value of the induced electromotive force and a number of coil turns;
determining a third instantaneous power of the wave power generation module based on the total electromotive force and an induced current; and
since the third instantaneous power changes over time, determining an average value of the third instantaneous power based on the average velocity of the wave motion to determine the wave power generation amount of the wave power generation module.

11. The method according to claim 4, wherein when the current sea state satisfies an extreme sea state condition, controlling, by the intelligent dispatching module, the buoyancy adjustment module to activate the protection mode, closing the photovoltaic power generation module and the wind power generation module, and adjusting the housing to submerge to a safe depth, includes:
monitoring a submergence depth of the housing in real time through a depth sensor;
automatically adjusting, by the intelligent dispatching module, a water storage volume of a water storage compartment based on the submergence depth, so that a buoyancy of the housing is balanced with a weight to maintain the safe depth;
determining the buoyancy of the housing based on a seawater density, the water storage volume of the water storage compartment, and a gravitational acceleration;
determining a tension of an anchor chain based on a lever arm between a buoyancy center and an anchor chain point and a housing weight;
determining the water storage volume of the water storage compartment based on the buoyancy of the housing and the housing weight; and
adjusting the submergence depth of the housing based on the tension of the anchor chain and the water storage volume.

12. The method according to claim 3, wherein the release condition includes a swing amplitude less than 0.5 m, a swing duration greater than 18 s, and a swing frequency less than 0.15 Hz.
